(19) United States
(12) Patent Application Publication
(10) Pub. No.: US 2003/0104335 A1
(43) Pub. Date: Jun. 5, 2003

(54) Rapid orthodontics treatment method after corticotomy and the skeletal anchorage plate

(76) Inventor: Kyu-Rhim Chung, Seoul (KR)

Correspondence Address: HOVEY WILLIAMS TIMMONS & COLLINS, 2405 GRAND BLVD., SUITE 400, KANSAS CITY, MO, 64108

(21) Appl. No.: 10/257,808

(22) PCT Filed: Apr. 16, 2001
(86) PCT No.: PCT/KR01/00628

(30) Foreign Application Priority Data
Apr. 17, 2000 (KR) 2000/20102

(51) Int. Cl. A61C 3/00

(52) U.S. Cl. 433/18; 433/21

(57) ABSTRACT

Disclosed is the rapid orthodontics treatment method after corticotomy and the skeletal anchorage plate. The method comprises the steps of: incising gums within a range established in consideration of a set of teeth to be corrected; incising front and rear surfaces of a cortical bone; suturing incised gums; and placing an orthodontic appliance on the teeth and applying tensioning force to the set of teeth, thereby to correct irregularities of the teeth. A supporting member comprises a securing part defined with threaded holes and secured to a palate bone such that the palate is straightly incised and a plurality of screws are respectively tightened through the threaded holes to the palate bone; and a supporting part integrated with the securing part and having eye portions on which both ends of a spring for pulling a

### TECHNICAL FIELD

The present invention relates to a rapid orthodontics treatment method after corticotomy and skeletal anchorage plate. In the present invention, continuity of a compact bone surrounding teeth is partially broken by performing corticotomy and then, flexural or tensile force is induced between a bracket assembly and a skeletal anchorage plate. The bracket assembly serves as an orthodontic appliance so that the several teeth can be rapidly moved and thereby corrected in unison in their irregularities. The effect of the procedure is that orthodontic treatment time can be shortened and a result that is similar to that obtained by performing orthognathic surgery under general anesthesia can be accomplished under local anesthesia.

### BACKGROUND ART

In implementing orthodontic treatment, in the case of a patient whose adulthood is attained, a tooth extracting operation is generally conducted for the purpose of converting an inferior aesthetic look this treatment is particularly applicable in the case of a protrusive occlusion of anterior teeth into a superior one.

Conventionally, an arch wire passes through an orthodontic appliance such as a bracket, a tube or the like, which is rigidly secured to a surface of a tooth, and then, flexural or tensile force is induced between teeth or between the tooth and an extra oral appliance. The force then moves the tooth toward the desired position.

In order to move anterior teeth rearward, a lengthy period of time is required due to the presence of a compact bone, which impedes rearward movement of roots of the teeth. That is to say, since the teeth are forced to move toward the compact bone, which is difficult to be modified in its structure, tooth root vanishment is provoked to a great extent. In other words, this tooth root vanishment is provoked by a mechanism in which an alveolar bone is compressed by flexural or tensile force applied to the roots of the teeth, and the teeth are moved into a space created by compression of the alveolar bone. As a consequence, in an attempt to cope with this limitation, osteotomy and corticotomy have been employed as surgical operation methods, in addition to the conventional orthodontic treatment.

Because the osteotomy should be performed under general anesthesia, it costs a great deal, and, due to the fact that the osteotomy cannot but involve a dangerous factor, an orthodontic patient may show severe reluctancy to the osteotomy. Also, while the corticotomy can be performed under local anesthesia without requiring a huge cost and involving dangerous factors, the corticotomy heretofore performed has revealed low treatment efficiency and thereby, is not currently in widespread use.

While the number of adult patients who want to convert their inferior aesthetic looks into superior ones steadily increases, it is impossible to satisfy those using the conventional orthodontic treatment method to a sufficient level. This fact is especially true of those who want changes within a short period of time. Therefore, a new orthodontic treatment method capable of solving restrictions caused in the conventional orthodontic treatment method has drawn considerable attention.

### DISCLOSURE OF THE INVENTION

The present invention has been made in an effort to solve the problems occurring in the conventional orthodontic treatment method. Such problems exist due to the fact that a tooth is moved as an alveolar bone is compressed by orthodontic treatment force applied to the tooth, and a lengthy period of time is required for completing orthodontic treatment. An objective of the present invention is to provide a rapid orthodontics treatment method after corticotomy and a skeletal anchorage plate. In this procedure, a portion of a cortical bone positioned inside the gums is removed under local anesthesia without necessitating general anesthesia, and a tooth and bone tissue are moved together by the medium of the skeletal anchorage plate. This plate serves as a newly devised orthodontic appliance, in such a way as to allow the tooth to be corrected in its irregularity. The result of this approach is that orthodontic treatment can be completed in a short period of time even in the case of an adult.

In order to achieve the above object, according to one aspect of the present invention the orthodontic treatment method is comprised of the following steps: incising gums within a range that is established in consideration of the set of teeth to be corrected; cutting out labial and lingual portions of the cortical bone that is positioned inside the gums, each in the form of a strip; suturing incised gums; and affixing a bracket assembly to lingual or labial surfaces of the set of teeth and securing a skeletal anchorage plate to the bone in the oral cavity. The result of these steps is that flexural or tensile force is continuously applied to the set of teeth in the direction in which orthodontic treatment is desired, thereby rapidly correcting irregularities of the set of teeth.

### BRIEF DESCRIPTION OF THE DRAWINGS

The above objects, and other features and advantages of the present invention will become more apparent after a reading of the following detailed descriptions. These descriptions should be read in conjunction with the drawings.

FIGS. 1a, 1b and 1c are schematic views for explaining an orthodontic treatment method through corticotomy according to the present invention;

FIGS. 2a and 2b are plan views illustrating states wherein orthodontic appliances are disposed in the mouth according to the present invention;

FIGS. 3a and 3b are perspective views each illustrating a cross-shaped skeletal anchorage plate, which constitutes an orthodontic appliance, in accordance with the first embodiment of the present invention;

FIGS. 4a and 4b are partially enlarged plan views each illustrating a state wherein the cross-shaped skeletal anchorage plate in accordance with the first embodiment of the present invention is used;

FIG. 5 is a perspective view illustrating an L-shaped skeletal anchorage plate, which constitutes an orthodontic appliance, in accordance with a second embodiment of the present invention;

FIG. 6 is a partially enlarged plan view illustrating a state wherein the L-shaped skeletal anchorage plate in accordance with the second embodiment of the present invention is used;

FIG. 7 is a perspective view illustrating an I-shaped skeletal anchorage plate, which constitutes an orthodontic appliance, in accordance with the third embodiment of the present invention;

FIGS. 8a and 8b are a partially enlarged plan view and a side view, respectively, illustrating a state wherein the I-shaped skeletal anchorage plate in accordance with the third embodiment of the present invention is used;

FIG. 9 is a perspective view illustrating a T-shaped skeletal anchorage plate, which constitutes an orthodontic appliance, in accordance with the fourth embodiment of the present invention;

FIGS. 10a and 10b are a partially enlarged plan view and a side view, respectively, illustrating a state wherein the T-shaped skeletal anchorage plate in accordance with the fourth embodiment of the present invention is used;

FIG. 11 is an exploded perspective view illustrating a screw-shaped skeletal anchorage plate in accordance with the fifth embodiment of the present invention;

FIGS. 12a and 12b are cross-sectional views respectively illustrating two situations: a state wherein a “female” anchor, which constitutes the screw-shaped skeletal anchorage plate in accordance with the fifth embodiment of the present invention, is threaded driven into an alveolar bone; and a state wherein a male body which also constitutes the screw-shaped skeletal anchorage plate, is fitted into the female body;

FIG. 13 is of perspective views illustrating a state wherein the screw-shaped skeletal anchorage plate in accordance with the fifth embodiment of the present invention, is used; and

FIG. 14 is a partially enlarged perspective view illustrating a labial bracket assembly, which is connected to the screw-shaped skeletal anchorage plate, in accordance with the fifth embodiment of the present invention.

### BEST MODE FOR CARRYING OUT THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

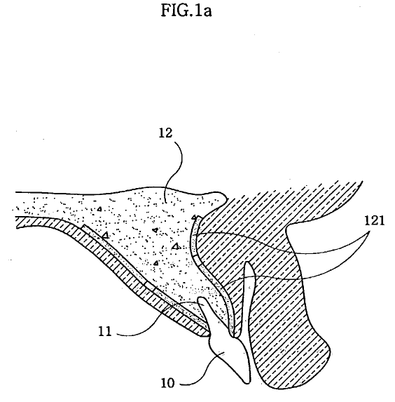

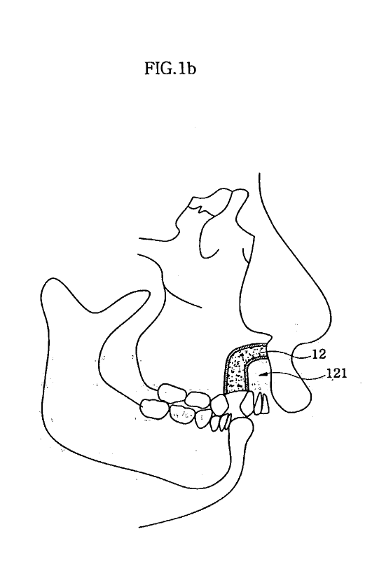

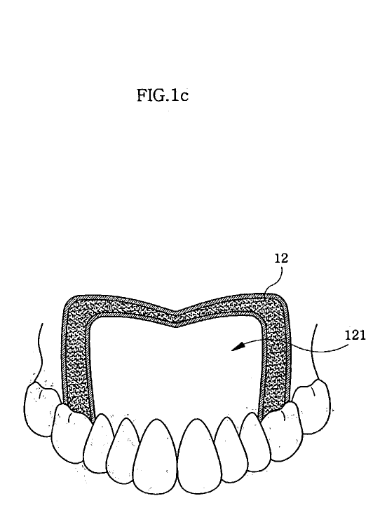

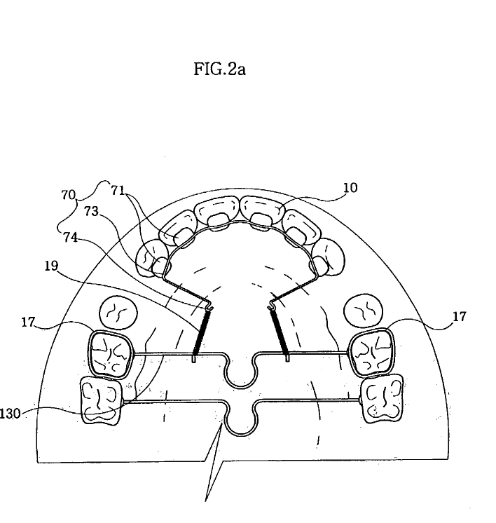

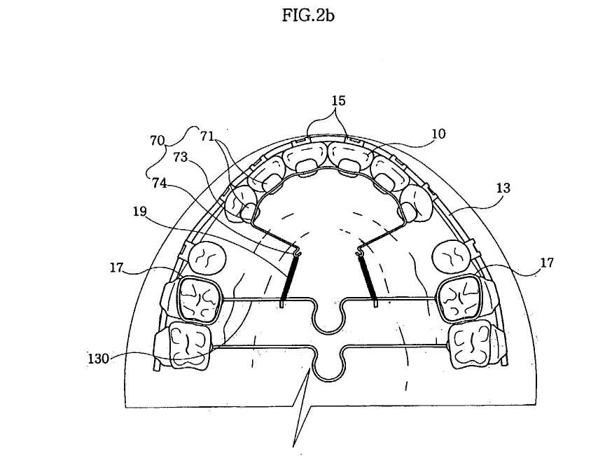

FIGS. 1a, 1b and 1c are schematic views for explaining an orthodontic treatment method through corticotomy according to the present invention. FIGS. 2a, 2b, 3a, 3b, 4a, 4b, 5, 6, 7, 8a, 8b, 9, 10a, 10b, 11, 12a and 12b are views illustrating skeletal anchorage plates that are used in an orthodontic treatment method through corticotomy according to the present invention and actual applications thereof.

As shown in FIGS. 1a, 1b and 1c, a root 11 of a tooth 10 is stuck into an alveolar bone 12 in such a way as to be permanently supported thereby. The outer surface of the alveolar bone 12 is covered by the cortical bone 121.

In implementing an orthodontic treatment method according to the present invention, a portion of the cortical bone 121 is removed, so that continuity of the compact bone surrounding the teeth 10 is partially broken. Then, in a state wherein several teeth 10 are grouped in such a way as to be capable of being integrally moved, flexural or tensile force is applied to the several teeth 10 to correct their irregularities.

To be more detailed, first, inner and outer gum portions of the teeth 10 to be corrected are incised, and then, inner and outer portions of the cortical bone 121, which is positioned inside the gums and covers the outer surface of the alveolar bone 12 are cut out in the form of a strip. Thereafter, the incised inner and outer gum portions are sutured.

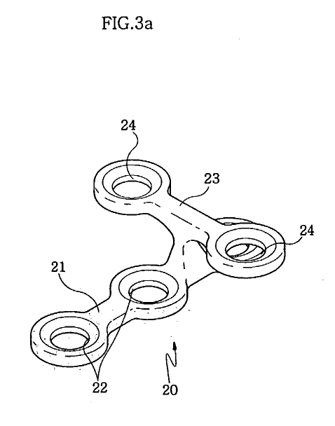

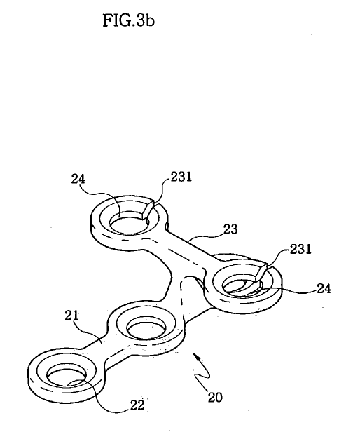

Second, as shown in FIG. 2a, an orthodontic appliance is placed on the teeth, and flexural or tensile force is continuously applied to the teeth in the direction in which orthodontic treatment is desired. That is to say, a lingual bracket assembly 70 is affixed to the lingual surfaces of the teeth to be correct, and a skeletal anchorage plate (in particular, see FIGS. 3a, 3b, 5, 7 and 9) is secured to a bone in the oral cavity. In this state, both ends of a spring 19 are hooked on the lingual bracket assembly 70 and the skeletal anchorage plate. By this procedure, flexural or tensile force is applied to the teeth to be corrected, in the orthodontic treatment direction, until orthodontic treatment is completed.

As flexural or tensile force is continuously applied to the teeth 10 to be corrected, the alveolar bone 12 as well as the teeth 10 are moved in the orthodontic treatment direction, with a view to reach the desired positions. For this reason, an orthodontic treatment implementing speed is doubled in comparison with the conventional orthodontic treatment method. Also, even if the teeth 10 are moved, it is possible to prevent the roots 11 of the teeth 10 from being damaged or disappearing entirely. It is also possible to prevent the periodontal tissues from being seriously enfeebled due to friction between the alveolar bone 12 and the roots 11 of the teeth 10, whereby the likelihood of ill effects can be minimized. Furthermore, as time goes by, the partially cut-out cortical bone 121 is restored to its original status.

There are two different ways of placing an orthodontic appliance on the teeth 10. First, an orthodontic appliance can be placed on the rear surfaces of the teeth 10, which is called a lingual orthodontic treatment method. Second, an orthodontic appliance can be placed on the front surfaces of the teeth 10, which is called a labial orthodontic treatment method.

In the present invention, the lingual orthodontic treatment method the labial orthodontic treatment method can be simultaneously or independently implemented.

Upon independently implementing the lingual orthodontic treatment method, as can be readily seen from FIG. 2a, the lingual bracket assembly 70 is affixed to lingual surfaces, that is, to the inner surfaces of the teeth to be corrected. Then, the skeletal anchorage plate is secured to a palate bone or a labial or lingual portion of the cortical bone 121 adjoining a molar tooth 16. The cortical bone is positioned inside the gums, or band segments 17 are respectively fitted around molar teeth and are connected with each other by a steel wire 130. Both ends of the lingual bracket assembly 70, which is affixed to the lingual surfaces of the teeth 10, are connected to the steel wire 130 through a pair of springs 19, respectively, whereby flexural or tensile force is continuously applied to the teeth 10.

Upon simultaneously implementing the lingual orthodontic treatment method and the labial orthodontic treatment method, as can be readily seen from FIG. 2b, the lingual bracket assembly 70 is first affixed to the lingual surfaces of the teeth to be corrected, and both ends of a pair of springs 19 are hooked on hook portions 74 formed at both ends of a steel wire 73, which constitutes the lingual bracket assembly 70 and the steel wire 130. The result of this procedure is that flexural or tensile force is continuously applied to the set of teeth and thereby lingual orthodontic treatment can be effectuated. In addition, labial brackets 15 are affixed to labial surfaces, that is, outer surfaces of the teeth to be corrected, and an arch wire 13 passes through the labial brackets 15 so that both ends of the arch wire 13 are fixed to the molar teeth. Again, flexural or tensile force is continuously applied to the set of teeth and thereby labial orthodontic treatment can be effectuated. At this time, the labial orthodontic treatment method is, implemented in such a way as to constitute an auxiliary means for reinforcing flexural or tensile force, which is generated by implementing the lingual orthodontic treatment method.

A lingual orthodontic appliance, which is used in implementing the lingual orthodontic treatment method, is comprised of the following components: the lingual bracket assembly 70, which is affixed to the lingual surfaces of the teeth to be corrected; the skeletal anchorage plate and the spring 19 serving as a connection member, which connects the lingual bracket assembly 70; and the skeletal anchorage plate. Together, these features induce the necessary flexural or tensile force.

The lingual bracket assembly 70 is comprised of a plurality of lingual brackets 71, which are affixed to the set of teeth to be corrected, the steel wire 73 which securely connects the lingual brackets 71 one with another, and the pair of hook portions 74, which are formed at both ends of the steel wire 73.

The skeletal anchorage plate can have a variety of configurations. For example, the skeletal anchorage plate can be formed to have a cross-shaped configuration as shown in FIGS. 3a and 3b.

The cross-shaped skeletal anchorage plate 20 has a securing part 21 and a supporting part 23 that are integrally formed with each other in such a way as to define the cross-shaped configuration. The securing part 21 is defined with three threaded holes 22 that are arranged in line one with another. The supporting part 23 is perpendicularly integrated with the securing part 21. The supporting part 23 has a pair of eye portions 24 that are formed at both ends of the supporting part 23, respectively. As shown in FIG. 3b, each eye portion 24 can be defined, at the rear zone thereof, with a slit 231 in a manner such that the end of the spring 19 can be easily hooked on the eye portion 24 through the slit 231.

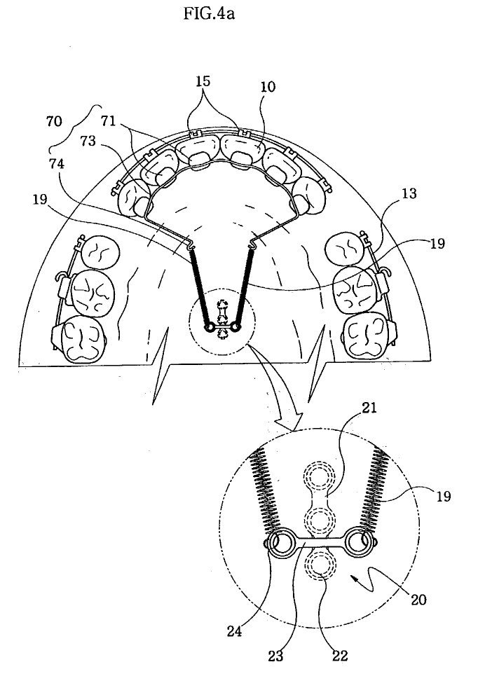

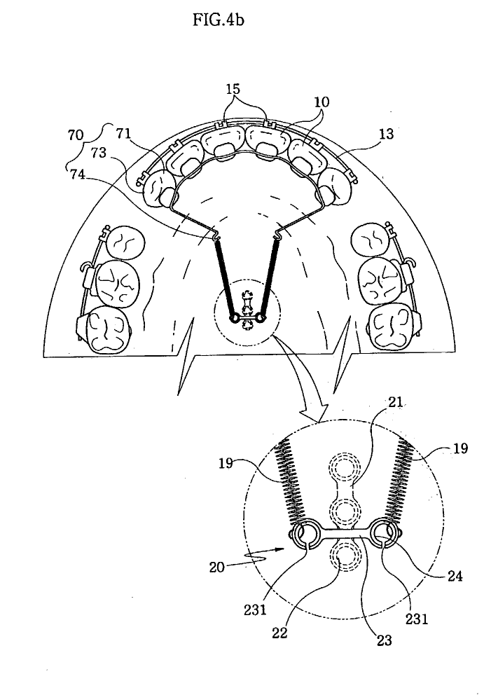

Upon installing the cross-shaped skeletal anchorage plate 20, a portion of a mucosa of the palate is straightly incised, the securing part 21 of the cross-shaped skeletal anchorage plate 20 is inside the incised mucosa, and screws are tightened through the threaded holes 22 to the palate bone. By this procedure, the securing part 21 is rigidly secured to the palate bone, and the supporting part 23, which is integrally connected with the securing part 21 to define the cross-shaped configuration, is exposed outside of the mucosa of the palate. Then, both ends of the pair of springs 19 are hooked on both ends of the lingual bracket assembly 70 (affixed to the lingual surfaces of the teeth to be corrected). The other ends of the pair of springs are attached to the pair of eye portions 24, which are respectively formed at both ends of the supporting part 23 of the cross-shaped skeletal anchorage plate 20, as shown in FIGS. 4a and 4b. By this arrangement, flexural or tensile force can be continuously applied to the teeth by the cross-shaped skeletal anchorage plate 20 via the pair of springs 19. At this time, since the cross-shaped skeletal anchorage plate 20 is rigidly secured to the palate bone, which is positioned inside the palate, it is possible to create flexural or tensile force required for moving an anterior set of teeth rearward, only with one cross-shaped skeletal anchorage plate 20.

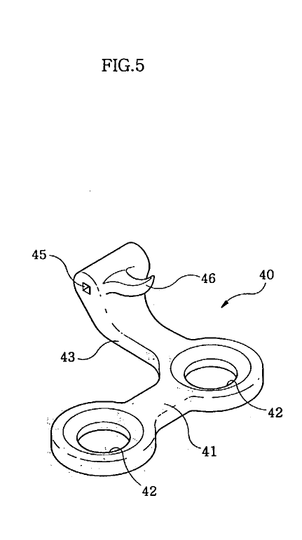

FIG. 5 is a perspective view illustrating an L-shaped skeletal anchorage plate, which constitutes an orthodontic appliance, in accordance with the second embodiment of the present invention. That is to say, the skeletal anchorage plate can be formed to have an L-shaped configuration.

In this second preferred embodiment of the present invention, a pair of L-shaped skeletal anchorage plates 40 are provided. Each L-shaped skeletal anchorage plate 40 has a securing part 41 and a supporting part 43, which are integrally formed with each other in such a way as to create an L-shaped configuration. The securing part 41 is defined with two threaded holes 42. The supporting part 43 is perpendicularly integrated with an end of the securing part 41. The supporting part 43 has a holding portion that is formed at the free end of the supporting part 43. The holding portion possesses an arch wired fastening hole 45 and a barb 46. The latter formed as a projection on the outer surface of the holding portion.

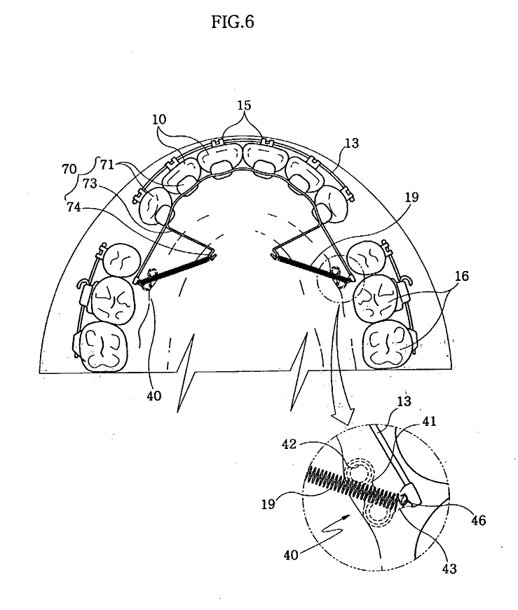

The pair of L-shaped skeletal anchorage plates 40 are secured to the labial or lingual portions of the cortical bone 121 adjacent to the molar teeth 16, whose portions are positioned inside the gums. In other words, labial or lingual gum portions which are placed outside or inside the molar teeth 16, are incised, and the securing parts 41 of the L-shaped skeletal anchorage plates 40 are respectively inserted inside the gum portions. Thereafter, when the securing parts 41 are brought into close contact with the cortical bone 121, screws are tightened through the threaded holes 42 to the cortical bone 121, whereby the securing parts 41 are rigidly secured to the cortical bone 121. Thereupon, after the incised gum portions are sutured, as can be readily seen from FIG. 6, both ends of the arch wire 13 are fitted firmly into the arch wire fastening holes 45 of the L-shaped skeletal anchorage plates 40, and both ends of the pair of springs 19 are hooked on both ends of the lingual bracket assembly 70 (affixed to the lingual surfaces of the teeth 10 to be corrected) and the projectedly formed barbs 46 of the L-shaped skeletal anchorage plates 40. By this procedure, flexural or tensile force can be continuously applied to the teeth by the L-shaped skeletal anchorage plates 40 via the pair of springs 19.

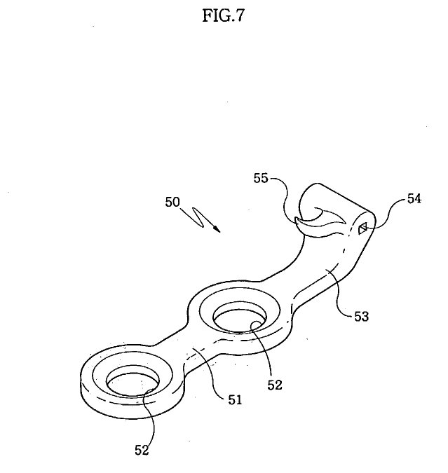

FIG. 7 is a perspective view illustrating an I-shaped skeletal anchorage plate which constitutes an orthodontic appliance, in accordance with the third embodiment of the present invention. In other words, the skeletal anchorage plate can be formed to have an I-shaped configuration.

In this third preferred embodiment of the present invention, a pair of I-shaped skeletal anchorage plates 50 are provided. Each I-shaped skeletal anchorage plate 50 has a securing part 51 and a supporting part 53, which are sin turn, integrally formed with each other in such a way as to define an I-shaped configuration. The securing part 51 is defined with two threaded holes 52. The supporting part 53 is successively integrated with the end of the securing part 51. The supporting part 53 has a holding portion that is formed at the free end of the supporting part 53. The holding portion possesses an arch wire fastening hole 54 and a barb 55. The latter is formed as a projection on the outer surface of the holding portion.

The pair of I-shaped skeletal anchorage plates 50, each constructed as mentioned above, are secured through the gums to the alveolar bone 12 inside or outside the molar teeth, in a manner such that the supporting parts 53 face the molar teeth, and the securing parts 51 are opposed to the molar teeth.

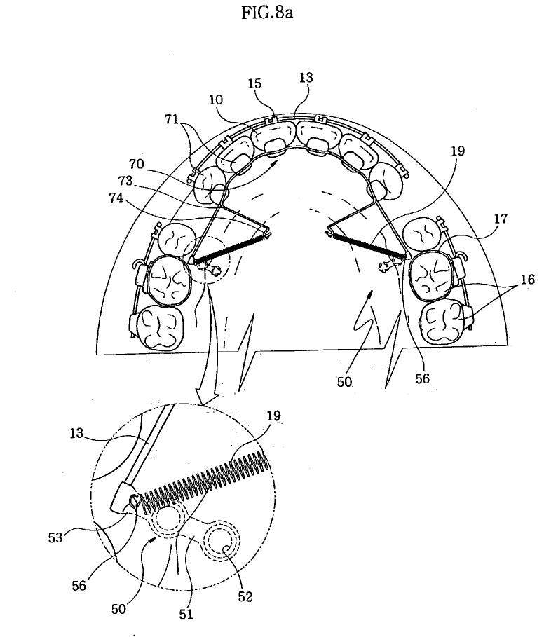

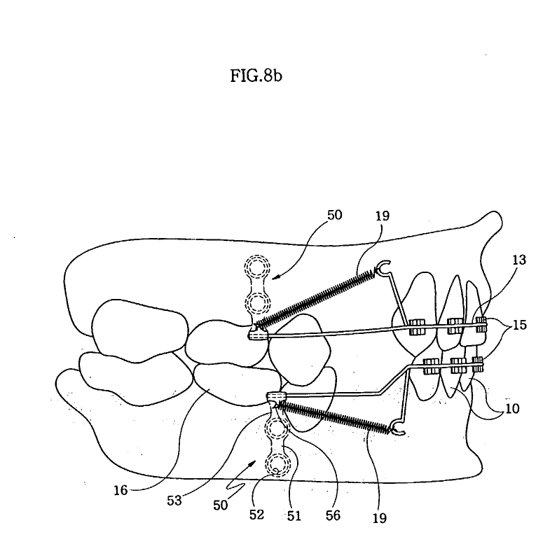

As can be readily seen from FIGS. 8a and 8b, both ends of the arch wire 13 are firmly fitted into the arch wire fastening holes 54 of the I-shaped skeletal anchorage plates 50, and both ends of the pair of springs 19 are hooked on both ends of the lingual bracket assembly 70 (affixed to the lingual surfaces of the teeth 10 to be corrected) and, at the other ends, to the barbs 55 of the I-shaped skeletal anchorage plates 50. By this procedure, flexural or tensile force can be continuously applied to the teeth by the I-shaped skeletal anchorage plates 50 via the pair of springs 19.

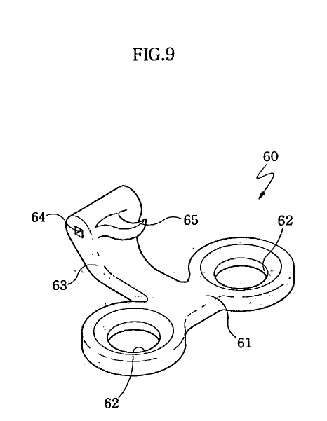

FIG. 9 is a perspective view illustrating a T-shaped skeletal anchorage plate which constitutes an orthodontic appliance, in accordance with the fourth embodiment of the present invention. In other words, the skeletal anchorage plate can be formed to have a T-shaped configuration.

As shown in FIG. 9, also, in this fourth preferred embodiment of the present invention, a pair of T-shaped skeletal anchorage plates 60 are provided. Each T-shaped skeletal anchorage plate 60 has a securing part 61 and a supporting part 63, which are integrally formed with each other in such a way as to create a T-shaped configuration. The securing part 61 is defined with two threaded holes 62. The supporting part 63 is perpendicularly integrated with the middle of the securing part 61. The supporting part 63 has a holding portion that is formed at the free end of the supporting part 63. The holding portion possesses an arch wire fastening hole 64 and a barb 65. The latter is formed as a projection on the outer surface of the holding portion.

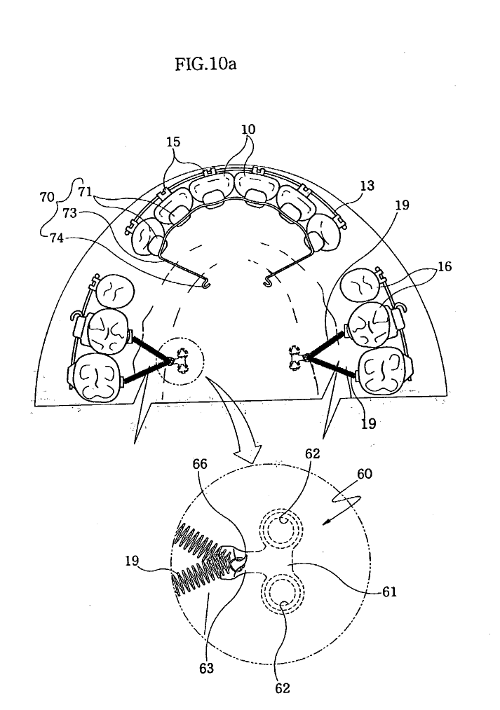

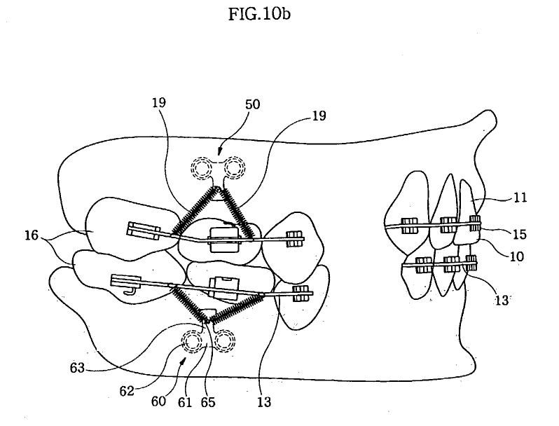

The pair of T-shaped skeletal anchorage plates 60, each constructed as mentioned above, are secured through the gums to the cortical bone 121 inside or outside the molar teeth, as shown in FIGS. 10a and 10b. At this time, each T-shaped skeletal anchorage plate 60 is secured to the cortical bone 121 in the same way as in the case of the L-shaped skeletal anchorage plate 40 and the I-shaped skeletal anchorage plate 50.

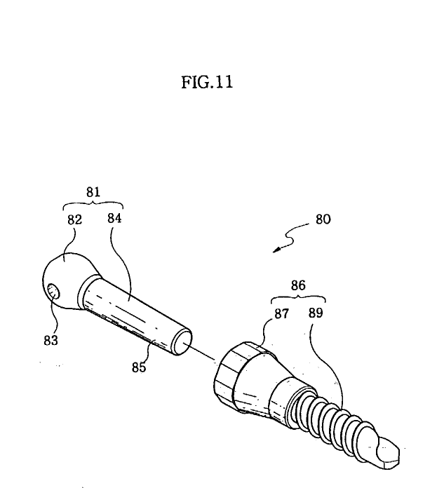

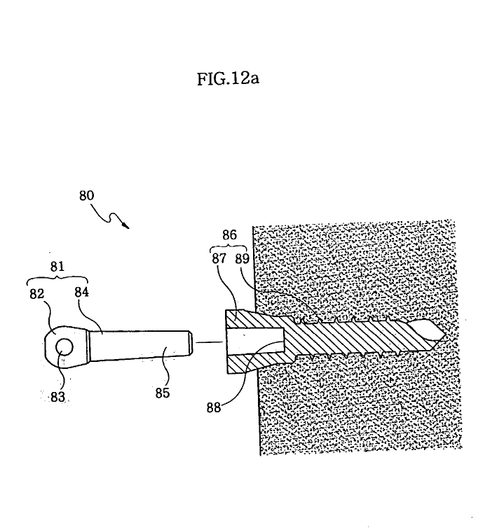

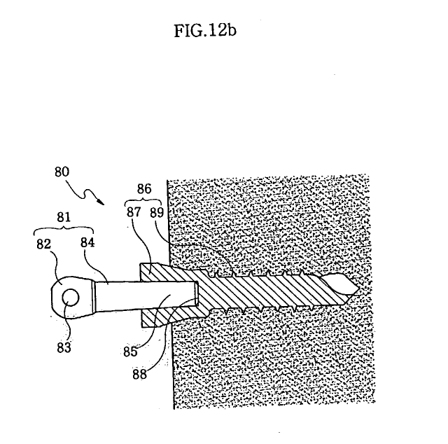

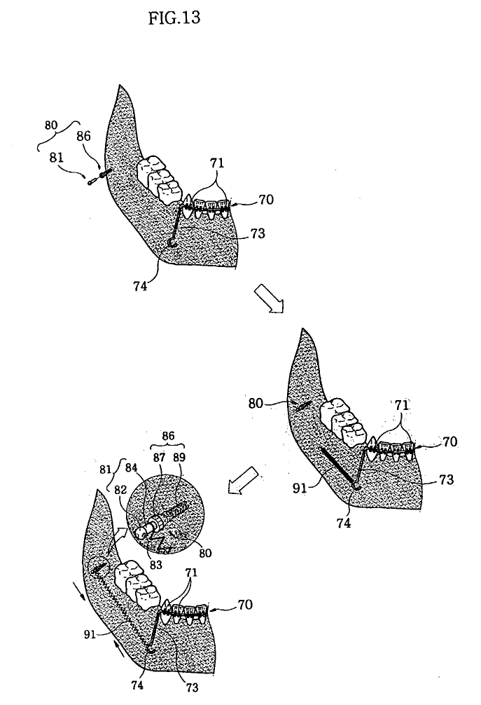

FIG. 11 is an exploded perspective view illustrating a screw-shaped skeletal anchorage plate in accordance with the fifth embodiment of the present invention. FIGS. 12a and 12b are cross-sectional views respectively illustrating a situation wherein a “female” anchor, which constitutes the screw-shaped skeletal anchorage plate, in accordance with the fifth embodiment of the present invention, is threaded into an alveolar bone as well as the situation wherein a “finale” pin, which also constitutes the screw-shaped skeletal anchorage plate, is fitted into the female body. Finally, FIG. 13 illustrates a state wherein the screw-shaped skeletal anchorage plate, in accordance with the fifth embodiment, of the present invention is used.

According to the present invention, after the gums are incised within the range that is established in consideration of the set of teeth to be corrected, the inner and outer portions of the cortical bone 121 positioned inside the gums are cut out in the form of a strip. The incised gums are then sutured in order to continuously apply flexural or tensile force to the set of teeth until they are corrected in their irregularities. After that, a labial bracket assembly 70 is affixed to the labial surfaces of the teeth. At this time a screw-shaped skeletal anchorage plate 80, in accordance with this fifth embodiment of the present invention, can be employed. Also, in this fifth embodiment of the present invention, a pair of screw-shaped skeletal anchorage plates 80 are provided.

In this fifth embodiment of the present invention, the labial bracket assembly 70 is comprised of a plurality of labial brackets 71 that are affixed to the outer surfaces, that is, the labial surfaces of the set of teeth to be corrected, and a steel wire 73 that securely connects the labial brackets 71 one with another. The wire is formed at both ends thereof with a pair of hook portions 74, respectively. The labial bracket assembly 70 is thus securely affixed to the labial surfaces of the teeth.

As shown in the drawings, the screw-shaped skeletal anchorage plate 80 is comprised of two bodies, that is, a “male” part 81 and a “fernale” part 86.

The “male” pin 81 is composed of a head part 82, which has an inserting hole 83, and a neck part 84, which is integrally connected to the lower end of the head part 82 and has a smaller diameter than the head part 82. The “female” anchor 86 is composed of a receiving part 87, in which the neck part 84 of the male body 81 is received, and a threaded part 89, which is integrally connected to the lower end of the receiving part 87.

The lower end portion of the neck part 84 of the male body 81 is formed as a wedge-shaped inserting portion 85. The receiving part 87, which is formed at the upper end of the female body 86, is defined with a receiving groove 88 into which the wedge-shaped inserting portion 85 of the male body 81 is fitted. The circumferential outer surface of the receiving part 87 is tapered toward the threaded part 89. The upper end surface of the receiving part 87 is defined with a driver groove, or the upper end of the receiving part 87 is formed to have the shape of a polygon so that a wrench can be used.

Upon installing the screw-shaped skeletal anchorage plate 80, constructed as mentioned above, the threaded part 89 of the “female” anchor 86 is first threaded into the alveolar bone outside the molar tooth. Since the lower end of the receiving part 87 is tapered toward the threaded part 89, when the screw-shaped skeletal anchorage plate 80 is threaded into the alveolar bone, the screw-shaped skeletal anchorage plate 80 can be rigidly coupled to the alveolar bone as if it is wedged into the alveolar bone.

After the “female” ahchor 86 is threaded into the alveolar bone, if the gum is healed up so that the gum is substantially integrated with the circumferential outer surface of the receiving part 87, the wedge-shaped inserting portion 85 of the neck part 84 of the “Omale” pin 81 is fitted into the receiving groove 88 defined in the receiving part 87 of the “female” anchor 86. Thereafter, as can be readily seen from FIG. 13, both ends of the spring 91 are respectively hooked on the neck part 84 of the “male” pin 81 and the hook portion 74 of the labial bracket assembly 70. As a result, flexural or tensile force can be continuously applied to the teeth to be corrected.

In this embodiment of the present invention, because the flexural or tensile force is applied to the teeth after the gum is healed up to the point of being substantially integrated with the “female” anchor 86, perfect isolation from the outside is effected, and thereby, infection due to invasion of germs is prevented. As a consequence, the likelihood of ill effects such as an inflammation can be minimized, and the threaded part 89 can be rapidly coupled with the bone.

As occasion demands, the “male” pin 81 and the “female” anchor 86 can be integrally formed with each other.

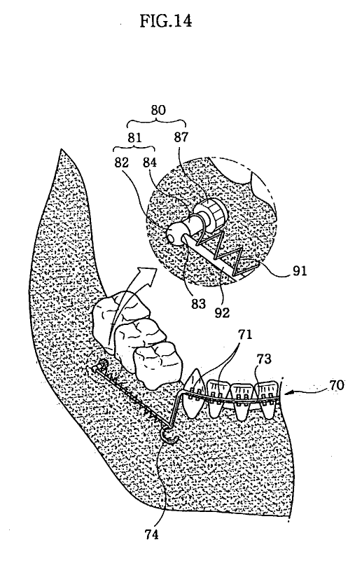

FIG. 14 is a partially enlarged perspective view illustrating another labial bracket assembly which is connected to the screw-shaped skeletal anchorage plate in accordance with the fifth embodiment of the present invention. A pair of extended steel wires 92 are integrally formed at both ends of the steel wire 73 of the labial bracket assembly 70 in a manner such that each of the extended steel wires 92 is inserted into the inserting hole 83 defined in the “male” pin 81 of the screw-shaped skeletal anchorage plate 80.

When the labial bracket assembly 70 is used, after the screw-shaped skeletal anchorage plates 80 are respectively seed to the alveolar bone outside the opposing molar teeth, both ends of a pair of springs 91 are hooked on the neck parts 84 of the “male” pins 81 and the hook portions 74 of the labial bracket assembly 70. The result of this procedure is to apply flexural or tensile force to the teeth to be corrected. At the same time, the free ends of the extended steel wires 92 are inserted in the inserting holes 83 defined in the head parts 82 of the “male” pins 81.

As the extended steel wires 92 are guided in the inserting holes 83 defined in the “male” pins 81 of the screw-shaped skeletal anchorage plates 80 while the set of teeth are moved rearward, reliable orthodontic treatment can be guaranteed due to stable and uniform movement of the teeth.

### INDUSTRIAL APPLICABILITY

The present invention describes an orthodontics treatment method through corticotomy that can be rapidly implemented at a reduced cost. This goal is accomplished through the following means: the lingual and labial portions of a cortical bone, which are positioned inside the gums, are cut out. Then, the set of teeth is corrected in its irregularities using a bracket assembly, which serves to group the set of teeth, and a skeletal anchorage plate. Also, with the present approach, it is possible to address the problem that a lengthy period of time is normally required for implementing orthodontic treatment for an adult and, due to this, the conventional orthodontic treatment method is not widely used. In other words, because the orthodontic treatment for an adult can be implemented in a short period of time with the present invention, the target age of orthodontic treatment can be extended to thirties or forties.

In addition to the savings of cost and time, the present orthodontic appliance can be installed in a more stable manner than traditional approaches. This added stability is created by the fact that a skeletal anchorage plate, which constitutes an orthodontic appliance, is secured by means of screws to the bone. The bone can be in either the center portion of the palate or in the lingual or labial surface of a bone positioned inside the gums. Thus, it is possible to replace most of existing orthodontic appliances with the present orthodontic appliance. Specifically, because of the fact that a cross-shaped skeletal anchorage plate is secured to a palatal bone that is sufficiently rigid, it is possible to create the flexural or tensile force required for implementing orthodontic treatment, only with one cross-shaped skeletal anchorage plate. Since it is sufficient to install only one cross-shaped skeletal anchorage plate, the orthodontic treatment can be implemented in a simple and convenient manner, much more preferable to the conventional complicated orthodontic appliance and orthodontic treatment method. In addition, the conventional orthodontic treatment method, in which band segments are fitted around molar teeth, suffers from as well as several defects. Among these, is the danger that of getting food particles get in between the band segments and the molar tooth the probability gumboil and caries is increased. However in the present invention, because it is possible to implement orthodontic treatment without fitting the band segment around the molar tooth, gumboil and caries can be effectively avoided.

1. (Deleted)

2. (Deleted)

3. (Deleted)

4. (Deleted)

5. (Deleted)

6. An orthodontic appliance adapted for continuously applying flexural or tensile force until a set of teeth are corrected in their irregularities, in a state in which gums are incised within a range established in consideration of the set of teeth to be corrected, labial and lingual portions of a cortical bone which is positioned inside the gums, are cut out in a lengthwise direction and incised gums are sutured, the orthodontic appliance comprising:
a bracket assembly including a plurality of brackets rigidly affixed to lingual or labial surfaces of the set of teeth and a steel wire which connects the brackets one with another and is formed at both ends thereof with a pair of hook portions, respectively; and
a skeletal anchorage plate secured to a bone in the oral cavity and connected with the bracket assembly via at least one spring so that flexural or tensile force is continuously applied to the set of teeth in a direction in which orthodontic treatment is desired.

7. The orthodontic appliance as claimed in claim 6, wherein the skeletal anchorage plate comprises a cross-shaped skeletal anchorage plate which has a securing part and a supporting part, the securing part being defined with threaded holes so as to be capable of being threaded to the bone which is positioned inside the palate, and the supporting part being perpendicularly integrated with the securing part in such a way as to define a cross-shaped configuration and having a pair of eye portions on which one ends of a pair of springs are respectively hooked.

8. The orthodontic appliance as claimed in claim 7, wherein each eye portion of the supporting part of the cross-shaped skeletal anchorage plate is defined, at a rear zone thereof, with a slit.

9. The orthodontic appliance as claimed in claim 6, wherein the skeletal anchorage plate comprises an L-shaped skeletal anchorage plate which has a securing part and a supporting part, the securing part being defined with threaded holes so as to be capable of being secured by means of screws to the cortical bone which is positioned inside the skin of the gums after the skin of the gums is partially incised outside or inside a molar tooth, and the supporting part being perpendicularly integrated with the securing part in such a way as to define an L-shaped configuration and having a barb which is projectedly formed in a manner such that the barb can be connected with the hook portion of the bracket assembly via the spring.

10. The orthodontic appliance as claimed in claim 6, wherein the skeletal anchorage plate comprises an I-shaped skeletal anchorage plate which has a securing part and a supporting part, the securing part being defined with threaded holes so as to be capable of being secured by means of screws to the cortical bone which is positioned inside the skin of the gums after the skin of the gums is partially incised outside or inside a molar tooth, and the supporting part being successively integrated with the securing part in such a way as to define an I-shaped configuration and having a barb which is formed as a projection in a manner such that the barb can be connected with the hook portion of the bracket assembly via the spring.

11. The orthodontic appliance as claimed in claim 6, wherein the skeletal anchorage plate comprises a T-shaped skeletal anchorage plate which has a securing part and a supporting part, the securing part being defined with threaded holes so as to be capable of being secured by means of screws to the cortical bone which is positioned inside the skin of the gums after the skin of the gums is partially incised outside or inside a molar tooth, and the supporting part being exposed outside of the skin of the gums when the T-shaped skeletal anchorage plate is installed, being perpendicularly integrated with the middle of the securing part in such a way as to define a T-shaped configuration and having a barb which is formed as projection in a manner such that the barb can be connected with the hook portion of the bracket assembly via the spring.

12. The orthodontic appliance as claimed in any one of the claims 9 to 11, wherein the supporting part is defined with an arch wire fastening hole which extends toward the set of teeth to be corrected.

13. The orthodontic appliance as claimed in claim 6, wherein the skeletal anchorage plate comprises a pair of band segments which are respectively fitted around opposing molar teeth and a steel wire which connects the pair of band segments with each other, and both ends of a pair of springs are hooked on hook portions formed at both ends of the bracket assembly and on the steel wire, so that flexural or tensile force is continuously applied to the set of teeth.

14. The orthodontic appliance as claimed in claim 6, wherein the skeletal anchorage plate comprises a screw-shaped skeletal anchorage plate which has a “male” part and a “female” part, the “male” part possesses a head part and a neck part which are integrally formed with each other, with a lower end portion of the neck part formed as a wedge-shaped inserting portion, the “female” part possesses a polygonal receiving part which is defined with a receiving groove into which the wedge-shaped inserting portion of the male body is interference-fitted and a threaded part which is integrally connected to a lower end of the receiving part and threaded to the bone positioned inside the gums.

15. The orthodontic appliance as claimed in claim 14, wherein a pair of extended steel wires are integrally formed at both ends of the steel wire of the bracket assembly in a manner such that each of the extended steel wires is inserted into an inserting hole which is defined in the male body of the screw-shaped skeletal anchorage plate.
